(19) United States
(12) Patent Application Publication
(10) Pub. No.: US 2003/0024181 A1
(43) Pub. Date: Feb. 6, 2003

(54) Window bead

(75) Inventor: Norman Burgess, Braintree (GB)

Correspondence Address: PIPER RUDNICK, P. O. BOX 64807, CHICAGO, IL, 60664-0807, US

(73) Assignee: Crittall Windows Limited, Braintree (GB)

(21) Appl. No.: 10/165,112

(22) Filed: Jun. 7, 2002

(30) Foreign Application Priority Data
Jun. 8, 2001 (GB) 0114041.7

(51) Int. Cl. E06B 3/30

(52) U.S. Cl. 52/204.53

(57) ABSTRACT

A window has an elongate frame member and a bead member both of which have mutually-engaging elements, for example holes or slots, at spaced locations along their length, the engagement elements of the frame being integrally formed therewith. The bead member may be attached to clip members incorporating elements for engagement with the frame. Alternatively, the (engagement elements of the bead member are constituted by projections integrally formed with the rest of the bead member.

### BACKGROUND OF THE INVENTION

The present invention relates to beading and in particular to beads for double glazed windows.

Window frames made from hollow extruded material can be formed in shaped sections. In GB 2264740A, the window frame has single longitudinal grooves and clips running the whole length of the frame for mounting a window unit. However, for reasons of structural integrity, a frame with a single thickness of material cannot include a continuous groove.

Beading for windows is at present attached to the frame by means of studs. Attachment of the studs is time-consuming and is normally undertaken on-site where working conditions may not be favourable and where components can easily be lost.

### SUMMARY OF THE INTENTION

The present invention seeks to overcome or reduce at least one of the above problems and to provide an arrangement requiring a lower total number of components.

According to a first aspect of the present invention, there is provided a window having an elongate frame member and a bed member both having mutually-engaging elements at spaced locations along their lengths, the engagement elements of the elongate frame member being integrally-formed therewith.

The engagement elements of the frame member are preferably openings such as holes or slots machined in the frame member during manufacture thereof.

The bead member is attached to a plurality of clip members, said clip members incorporating the engagement elements for engagement with the frame member.

Alternatively, the engagement elements of the bead member may be integrally formed therewith. The engagement elements are preferably readily engageable.

According to a second aspect of the present invention, there is provided a window having an elongate frame member and a bead member both having mutually-engaging elements at spaced locations along their lengths, the engagement elements of the bead member being constituted by projections therefrom. The projections are preferably formed on a plurality of clip members attached to the bead member. Alternatively, the projections are integrally formed with the rest of the bead member.

According to a third aspect of the present invention, there is provided a kit of parts for making a window comprising elongate frame members having apertures there through at spaced locations, bead members incorporating engagement formations, and a plurality of clip members having first portions for engaging with the formations on the bead members and second portions for engagement with the apertures through the frame members.

### BRIEF DESCRIPTION OF THE DRAWINGS

Preferred embodiments of the present invention will now be described, by way of example only, with reference to the accompanying drawings, of which:

FIG. 1 shows a prior art window;

FIG. 2 shows a window in accordance with a first embodiment of the present invention;

FIGS. 3, 4 and 5 respectively show side, top and front views of a clip member for use in the assembly of the window of FIG. 2 and showing preferred dimensions in mm;

FIG. 6 shows a window in accordance with a second embodiment of the present invention;

FIG. 7 shows a front view on an enlarged scale of a bead of the window of FIG. 6; and

FIG. 8 is a section on the line A of FIG. 7.

### DESCRIPTION OF THE PREFERRED EMBODIMENTS

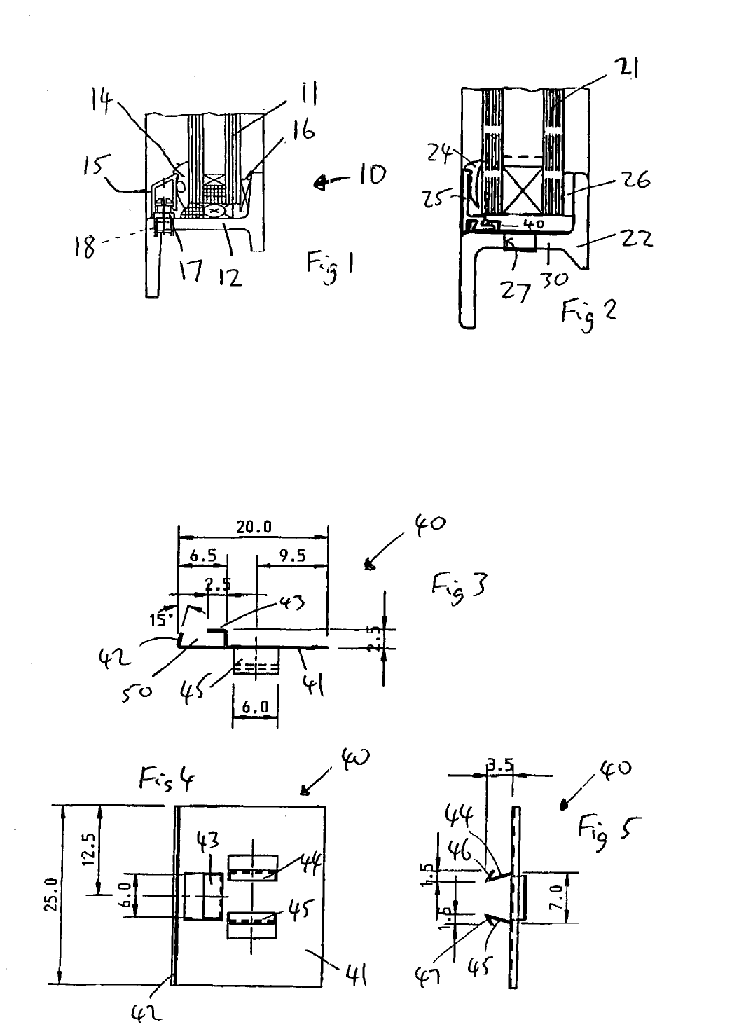

Referring to the drawings, FIG. 1 shows a prior art window 10 in which a double-glazed unit 11 is secured in a frame 12. At the exterior face of the window a sealing gasket 14 is held in position by an extruded aluminium bead 15, with mastic tape 16 being provided at the interior face of the window.

Bead 15 comprises an inverted substantially U-shaped channel member the arms of which clip over the heads of studs 17 provided at spaced locations along the window frame. The lower ends of the studs 17 are threaded and are screwed into spaced threaded holes 18 in the frame. The provision of threaded holes 18 increases manufacturing time. Moreover, screwing in the studs 17 is a laborious process yet it cannot be performed in the factory but needs to be undertaken on site after the glazed unit 11 has been put into position.

FIG. 2 shows a window 20 in accordance with a first embodiment of the present invention comprising a double glazed unit 21 in a frame 22. Unit 21 typically has a thickness of 20 mm. A gasket or vision strip 24 and a length of mastic tape 26 are provided. The mastic tape typically has cross-sectional dimensions of 12 mm×3 mm.

During manufacture of frame 22 it has substantially square holes 27 punched therein at spaced locations along its length. The holes 27 are located in a central position in limb 30 of the frame. The holes typically have 8 mm sides.

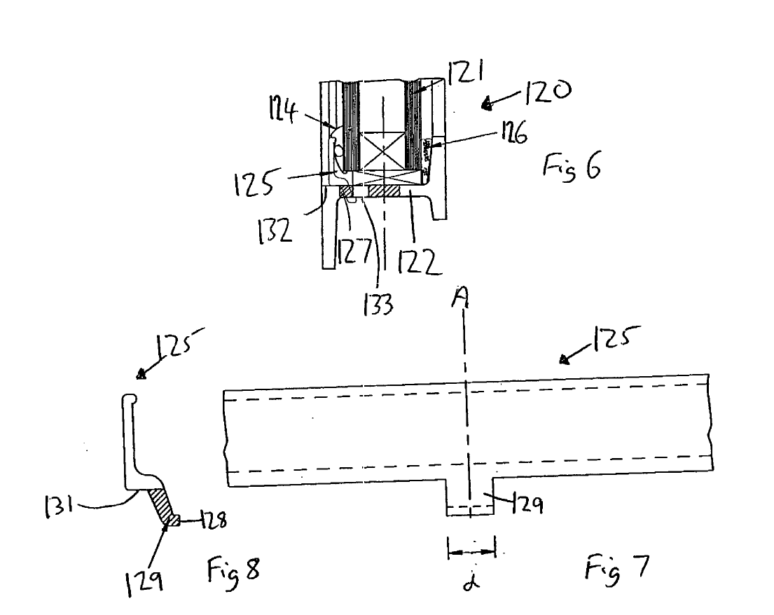

Bead 25 is formed as a member of extruded aluminium having a cross-sectional shape similar to that of a high-backed chair, but with an angled front leg portion and a foot portion extending forwardly from the bottom of the leg portion. At spacings along its length, corresponding to the distance between holes 27 in the frame, the bead is engaged by clip members 40, see FIGS. 3 to 5. The clip members 40 are of spring quality stainless steel and typically have a thickness of 0.25 mm. Other preferred dimensions in mm are indicated in FIGS. 3 to 5. Each clip member comprises a generally rectangular base plate portion 41 having a front edge 42, the whole of which is raised at an inclination of 15° to the vertical. Stamped out upward is from the portion 41 is an L-shaped tab 43 which extends part of the way towards front edge 42. Stamped out downwardly from the portion 41 at a location just behind tab 43 are two tang portions 44, 45, which extend perpendicularly to tab 43, i.e. await from the front edge. Tang portions 44, 45 extend inwardly towards each other and terminate in inclined feet 46, 47.

During assembly of the window 20, tang portions 44, 45 of clip members 40 are sprung into respective holes 27 along the frame 22. Tape 26 and unit 21 are then inserted. Bead 25 is then attached to the clip members 40 with its front leg portion being held in the space 50 formed between front edge 42 and tab 43. Assembly is completed by inserting gasket 24.

Preferably, the frame is of rolled material, e.g. steel. In this case, it is possible only to form frames having a relatively simple cross-sectional shape and of single thickness. Window mounting arrangements described in the prior art, for example GB 2264740A, are not suitable.

An advantage of the above arrangement is that it is stable and yet requires fewer components than prior windows. The need for separate components in the form of studs is avoided which saves manufacturing expenditure and leads to a quick and simple method of assembly.

In view of the reduced dimensions of bead 25 as compared with the prior bead 15, a very compact arrangement can be achieved which provides windows with a substantially reduced total thickness.

The holes 27 can be simply produced in frame 22 since they are spaced well away from the edges. Moreover, the provision of a relatively large single hole for each pair of tangs 44, 45 also contributes to ease of manufacture in addition to ease of galvanising.

In a modification, each hole 27 may be replaced by a pair of parallel slots in the frame, one for each of a pair of tangs 44, 15. The clip members 40 do not need to be resilient, but this means that the arrangement is not as stable during assembly.

In other modifications, the bead may be arranged to fit directly into the frame. For example, FIG. 6 shows a windows 120 in accordance with a second embodiment of the present invention comprising a double-glazed unit 121 in a frame 122. Unit 121 also has a typical thickness of 20 mm. A gasket 124 and a length of mastic tape 126 are provided.

During manufacture of the frame 122, it has slots 127 machined therein at spaced locations along its length. The slots are positioned under the lower edge of the front face of the unit 121, and extend parallel thereto.

Bead 125 is formed as a member of extruded aluminium having a substantially L-shaped cross-section. At spacings along its length equal to the spacings between slots 127, the bead is provided with projections in the form of tangs 129 each having a lip 128. Tangs 129 preferably have a length ‘d’ of 12 mm and their centre-to-centre spacing is 300 mm. Slots 127 have a length of 12 mm or slightly greater.

During assembly of the window 120, tangs 129 are inserted in respective slots 127 and the gasket 114 serves to hold the bead in position with the upper surface of the lip 128 engaging the lower surface 133 of the frame and with surface 131 of the bead engaging upper surface 132 of the frame.

A further advantage of the above-described embodiment is that even fewer components are required than for the first embodiment.

Various modifications may be made to the above-described arrangement. For example the size and spacing of the tangs 129 can be selected as desired. The tangs may be replaced with projections of any other convenient shape, with corresponding openings being provided in the frame. However, substantially planar projections are preferred for ease of manufacture of both the bead and the frame. The projections may be resilient and may be arranged to be securely held in the openings in the frame even before the insertion of gasket 124.

In another modification, the frame 122 is formed with integral projections which are received by corresponding openings in the bead 125; however such an arrangement increases the manufacturing costs of both the bead and the frame.

The frames 22, 122 may be part of a fixed window or an opening window.

It will be understood that the above description of the present invention is susceptible to various modifications, changes and adaptions.

What is claimed is:

1. A window having an elongate frame member with engagement elements at spaced locations along its length, and having a bead member with further engagement elements at spaced locations along its length, wherein said engagement elements of said frame member and said bead member are mutually engaging, said engagement elements of said frame member being integrally-formed therewith.

2. A window according to claim 1, wherein said engagement elements of said frame member are openings therein.

3. A window according to claim 1, wherein said bead member is attached to a plurality of clip members, said clip members incorporating said engagement elements of said bead member.

4. A window according to claim 3, wherein each of said clip members includes a base plate having first and second major surfaces and being provided with engagement means for engagement with said bead member, said base plate engagement means extending from said first major surface of the base plate and including a raised edge of said base plate and a tab spaced therefrom.

5. A window according to claim 4, wherein said base plate is provided with said engagement elements of said bead member in the form of projections from said second major surface of said base plate.

6. A window according to claim 5, wherein said projections are resilient.

7. A window according to claim 1, wherein said engagement elements of said bead member are integrally formed therewith.

8. A window having an elongate frame member with engagement elements at spaced locations along its length and having, a bead member with further engagement elements at spaced locations along its length, wherein said engagement elements of said frame member and said bead member are mutually engaging, said engagement elements of said bead member being constituted by projections therefrom.

9. A window according to claim 8, wherein said projections are resilient.

10. A window according to claim 8, wherein said projections are formed on a plurality of clip members attached to said bead member.

11. A window according to claim 10, wherein said projections are resilient.

12. A window according to claim 10, wherein each of said clip members includes a base plate having first and second major surfaces and being provided with engagement means for engagement with said bead member, said base plate engagement means extending from said first major surface of the base plate and including a raised edge of said base plate and a tab spaced therefrom.

13. A window according to claim 12, wherein said base plate is provided with said engagement elements of said bead member in the form of projections from said second major surface of said base plate.

14. A window according to claim 13, wherein said projections are resilient.

15. A window according to claim 8, wherein said projections are integrally formed with the rest of the bead member.

16. A window according to claim 15, wherein said projections are resilient.

17. A kit of parts for making a window comprising elongate frame members having apertures there through at spaced locations, bead members incorporating engagement formations, and a plurality of clip members having first portions for engaging with the formations on said bead members and second portions for engagement with the apertures through said elongate frame members.
